(19) United States
(12) Patent Application Publication
(10) Pub. No.: US 2010/0002345 A1
(43) Pub. Date: Jan. 7, 2010

(54) RADIO FREQUENCY SWITCH ELECTROSTATIC DISCHARGE PROTECTION CIRCUIT

(75) Inventors: James P. Young, Cedar Rapids, IA (US); Ken N. Warren, Anamosa, IA (US); Edward F. Lawrence, Marion, IA (US)

Correspondence Address: SMITH FROHWEIN TEMPEL GREENLEE BLAHA, LLC, Two Ravinia Drive, Suite 700, ATLANTA, GA, 30346, US

(73) Assignee: Skyworks Solutions, Inc., Woburn, MA (US)

(21) Appl. No.: 12/166,613

(22) Filed: Jul. 2, 2008

(51) Int. Cl. H02H 9/00

(52) U.S. Cl. 361/56

(57) ABSTRACT

An electrostatic discharge (ESD)-protected radio frequency (RF) transceiver switching circuit includes two or more switchable RF transmit and receive port circuits, a diode-based ESD-protection circuit, and a voltage-dividing circuit. The voltage-dividing circuit, which can be a switching circuit, minimizes the number of diode devices needed to protect against ESD by dividing the voltage at the antenna node down to a lower voltage across the diode devices.

### BACKGROUND

Electrostatic discharge refers to an undesirable burst of current resulting from the instantaneous electrostatic creation of a large voltage potential in an integrated circuit chip or other electronic device. Electrostatic discharge (ESD) typically occurs when a person transfers a static charge by touching the device during manufacturing or use of the device, though ESD by induction can also occur when an electrically charged object is placed near the electronic device. A typical static discharge potential is on the order of hundreds or even thousands of volts, which is generally large enough to find an undesirable path to ground through sensitive circuit elements that are easily damaged or destroyed by the resulting current.

To avoid adverse effects of ESD on electronic devices, ESD protection circuits can be included. Some ESD protection circuits are external to the device to be protected. For example, a chip that processes radio frequency (RF) signals, such as a transmitter or receiver chip, can be protected to some extent by connecting a direct current (DC)-blocking capacitor between the chip's RF port and the antenna. Other ESD protection circuits can be internal to the device to be protected. For example, it is known to include a number of diodes connected in series with each other between the point to be protected and ground. When the ESD voltage at the point to be protected rises above a threshold voltage equal to the sum of the voltage drops across the diodes, the diodes turn on and thus provide a low-impedance path to safely discharge the current to ground.

Portable radio frequency (RF) transceivers such as mobile wireless telephones (also known as cellular telephones) present challenges to circuit designers desiring to include ESD protection. A major design consideration is chip area (commonly referred to in the art as chip real estate) economy. It is desirable to minimize the number of ESD protection diodes or similar devices, so as to economize on chip real estate. That mobile wireless telephones commonly have several points susceptible of ESD protection compounds this problem, as it is undesirable to provide strings of diodes at numerous such points.

### SUMMARY

In exemplary embodiments, the present invention relates to an ESD-protected RF transceiver switching circuit for a mobile wireless telecommunications device. The switching circuit includes a plurality of switchable RF transmit and receive port circuits, a voltage-dividing circuit, and an ESD-protecting diode circuit.

Each of the transmit and receive port circuits has a port node, an activation or control input (node), and a switched node. A signal applied to the activation input turns the transmit or receive port circuit on or off, i.e., activates or deactivates it. The switched node of each of the transmit and receive port circuits is coupled to a common antenna node, at which an antenna is coupled in embodiments in which the switching circuit is included in a mobile wireless telecommunications device. (As used in this patent specification (“herein”), the term “coupled” means connected via zero or more intermediate elements.)

The voltage-dividing circuit has a first node coupled to the common antenna node and a second node coupled to the switched node of at least one of the transmit and receive port circuits. The voltage-dividing circuit can have any suitable function in addition to dividing down the voltage that appears at the antenna node. In an exemplary embodiment, it functions as a switch.

The diode circuit is coupled between the second node of the voltage-dividing circuit and a ground node. The diode circuit provides a discharge path to ground in the event that ESD strikes the antenna node or one or more of the transmit and receive port circuits. The diode circuit comprises a plurality of diode devices connected in series with each other. By coupling the diode circuit on the other side of the voltage-dividing circuit from the antenna node, the voltage swing that the diode circuit experiences will be less than that which the antenna node experiences, thereby achieving a degree of ESD protection that a diode circuit could otherwise achieve only by employing many more diodes.

Other systems, methods, features, and advantages of the invention will be or become apparent to one with skill in the art upon examination of the following figures and detailed description. It is intended that all such additional systems, methods, features, and advantages be included within this description, be within the scope of the invention, and be protected by the accompanying claims.

### BRIEF DESCRIPTION OF THE FIGURES

The invention can be better understood with reference to the following figures. The components within the figures are not necessarily to scale, emphasis instead being placed upon clearly illustrating the principles of the invention. Moreover, in the figures, like reference numerals designate corresponding parts throughout the different views.

FIG. 1 is a block diagram of a mobile wireless telecommunications device, in accordance with an exemplary embodiment of the invention.

FIG. 2 conceptually illustrates the operation of the RF switching circuit of the device of FIG. 1.

FIG. 3 is a block diagram of the RF switching circuit of the device of FIG. 1.

FIG. 4A is a portion of a schematic diagram of the RF switching circuit of FIG. 3.

FIG. 4B is a continuation of the schematic diagram of FIG. 4A.

### DETAILED DESCRIPTION

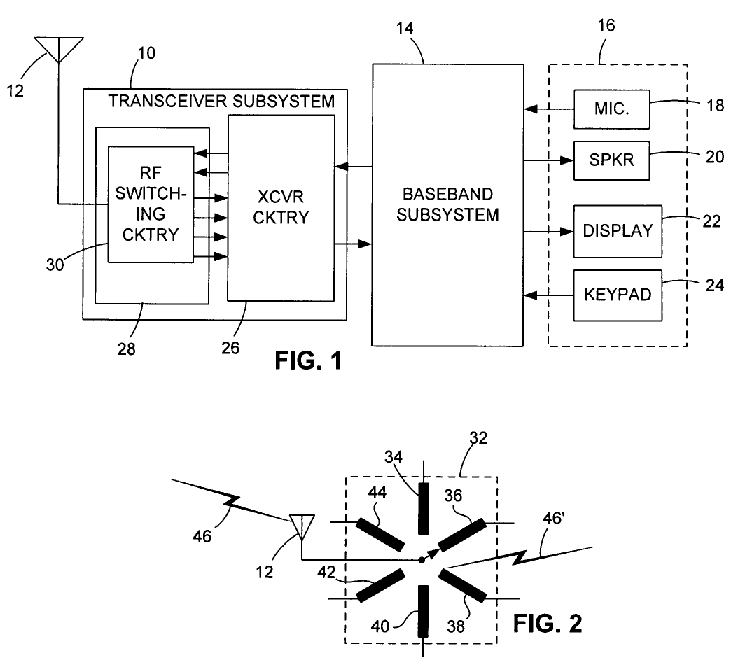

As illustrated in FIG. 1, in accordance with an exemplary embodiment of the invention, a mobile wireless telecommunications device (e.g., a cellular telephone or similar mobile wireless user equipment) includes a radio frequency (RF) transceiver subsystem 10, an antenna 12, a baseband subsystem 14, and a user interface section 16. As in a conventional cellular telephone or similar device, user interface section 16 includes a microphone 18, a speaker 20, a display 22 and a keyboard 24, all coupled to baseband subsystem 14. The RF transceiver subsystem 10 includes transceiver circuitry 26 and front-end circuitry 28. Front-end circuitry 28 includes RF switching circuitry 30 with novel electrostatic discharge (ESD) protection, as described below. Although not shown for purposes of clarity, front-end circuitry 28 also includes any other elements that would commonly be included in such portions of an RF transceiver, such as power amplifiers and power controllers. Although similarly not shown for purposes of clarity, transceiver circuitry 26 includes the remaining elements that would commonly be included in RF transceivers of this type, such as up-conversion and down-conversion circuitry, low-noise amplifiers, filters, etc. But for the ESD protection features of RF switching circuitry 30 or other novel aspects described herein, the mobile wireless telecommunications device can be of conventional design. As persons skilled in the art to which the invention relates understand how to make and use such conventional devices, those aspects of the telecommunications device that are conventional are not described in further detail herein.

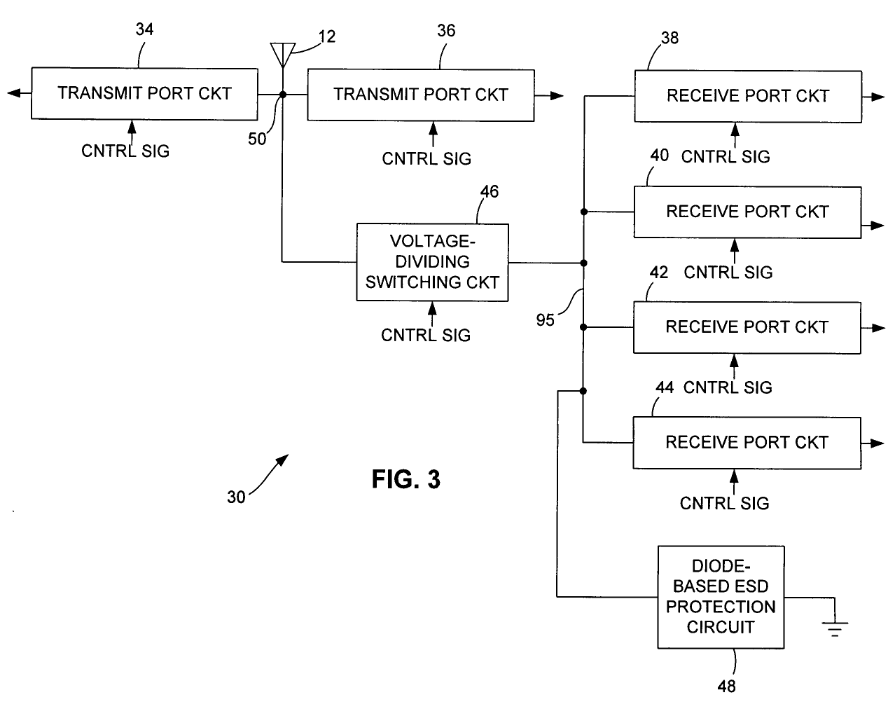

The RF switching circuitry 30 operates in the manner illustrated in FIG. 2. That is, in the exemplary embodiment of the invention it functions as a conceptual single-pole, six-throw (SP6T) RF switch 32, where the pole terminal is coupled to antenna 12, two of the throw terminals are respectively coupled to two RF transmit port circuits 34 and 36, and four of the throw terminals are respectively coupled to four receive port circuits 38, 40, 42 and 44. In the absence of ESD protection, if ESD 46 should strike antenna 12 or, during manufacturing of the telecommunications device, the circuit node (e.g., of a circuit board, chip, or module) to which antenna 12 is to be connected, the resulting current could damage sensitive electronic elements in transceiver subsystem 10. Similarly, if ESD 46′ should strike a circuit node on one of transmit and receive port circuits 34-44 during manufacturing, it could likewise damage such sensitive electronic elements.

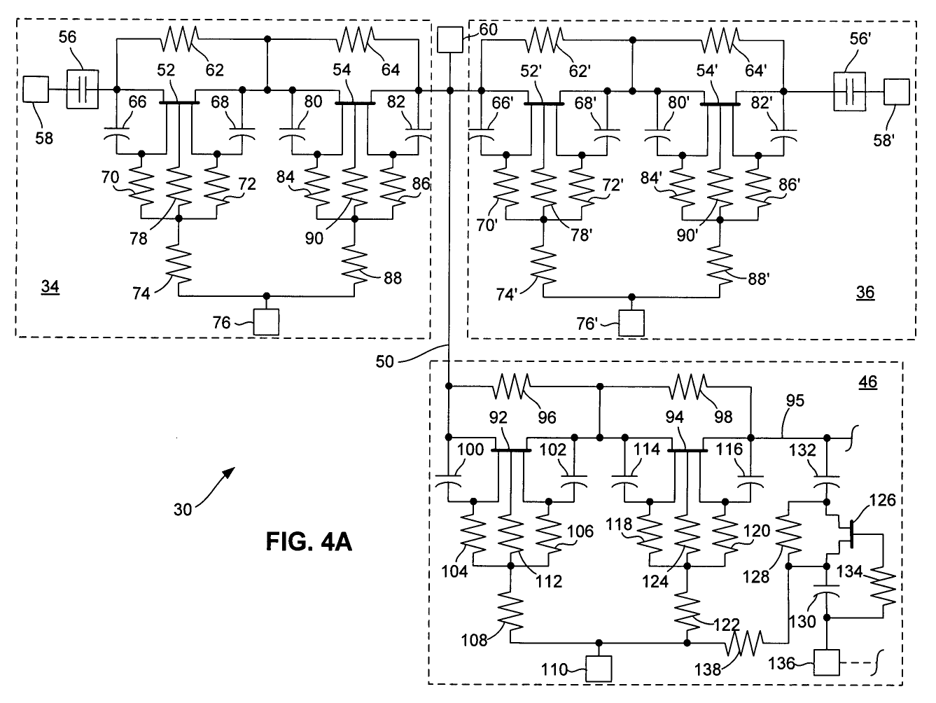

As illustrated in FIG. 3, RF switching circuitry 30 includes a voltage-dividing switching circuit 46 and a diode-based ESD protection circuit 48, in addition to transmit port circuits 34 and 36 and receive port circuits 38, 40, 42 and 44. Each of transmit and receive port circuits 34-44 has a node (referred to herein as a switched node) that is coupled (via switching circuit 46) to the antenna node 50. Each of transmit and receive port circuits 34-44 also has an input (referred to herein as an activation input) that can receive a control signal that activates or deactivates that transmit or receive port circuit. As persons skilled in the art understand, a controller, which can be included in RF switching circuitry 30, elsewhere in RF transceiver subsystem 10, or in baseband subsystem 14, generates the control signals in the conventional manner in accordance with the mode of operation of the telecommunications device and accordingly selects which one of transmit and receive port circuits 34-44 is active and which ones are inactive. (As the controller is conventional and not relevant to the ESD protection to which the invention relates, it is not shown in the drawings for purposes of clarity.) For example, transmit port 34 can be active, i.e., in a transmit mode, while the remaining transmit and receive ports 36-44 are inactive. When one of transmit port circuits 34 and 36 is active, the telecommunications device is transmitting, and when one of receive port circuits 38-44 is active, the telecommunications device is receiving. The telecommunications device has multiple transmit and receive modes that relate to the use of different telecommunications standards, frequency bands, etc. Each of transmit port circuits 34 and 36 can be used to transmit in a different mode from the other, e.g., on a different frequency band. Similarly, each of receive port circuits 38-44 can be used to receive in a different mode from the others. The selection of the various transmit and receive modes by a suitable controller is conventional and therefore not described in further detail herein.

Another node (referred to herein as an input port node) of each transmit port circuits 34 and 36 is coupled to other transmitter circuitry (e.g., a power amplifier), as noted above. Similarly, an output port node of each of receive port circuits 38-44 is coupled to other receiver circuitry (e.g., low-noise amplifier, down-converter, demodulator, etc.), as noted above. Thus, when one of transmit port circuits 34 and 36 is activated, the signal produced by such other circuitry is routed to antenna 12 so that it can transmitted. When one of receive port circuits 38-44 is activated, it routes the signal from antenna 12 to other circuitry so that it can be received.

Voltage-dividing switching circuit 46 also has an input connected to antenna node 50 as well as an output connected to an input of each receive port circuits 38-44. Voltage-dividing switching circuit 46 further has an activation input through which it can be turned on or off, i.e., in a switch-like manner, depending on the mode of operation of the telecommunications device. Switching voltage-dividing switching circuit 46 off during transmit mode isolates receive port circuits 38-44, and thereby reduces the generation of undesirable harmonics. In addition to this switching function, voltage-dividing switching circuit 46 also has the characteristic of a voltage divider. That is, the voltage at its output is a fraction of the voltage at its input, i.e., at antenna node 50.

Diode-based ESD protection circuit 48 is connected between the output of voltage-dividing switching circuit 46 (at a node 95) and a ground node. In this arrangement, as described more fully below, diode-based ESD protection circuit 48 discharges to ground any potentially harmful ESD that is present at antenna node 50 or at any of the inputs or outputs of any of transmit and receive port circuits 34-44.

It should be noted that the subsystems and other elements shown in FIG. 1 can be embodied in one or more integrated circuit chips, and that the chips can be packaged or modularized in the telecommunications device in any suitable manner. The packaging or other modularization of the subsystems and other circuitry need not correspond to the arrangement in which the elements are shown in FIG. 1. For example, although RF switching circuitry 30 and transceiver circuitry 26 are shown as separate and individual elements, in other embodiments they could be packaged together or otherwise integrated with each other. In the exemplary embodiment, front end module 28, which contains the ESD-protected RF switching circuitry 30, is embodied in a multi-chip module (MCM) package (not shown). The RF switching circuitry 30 can be a chip having input/output (I/O) pads that can be connected via bondwires (not shown) to other I/O pads of other chips in the MCM.

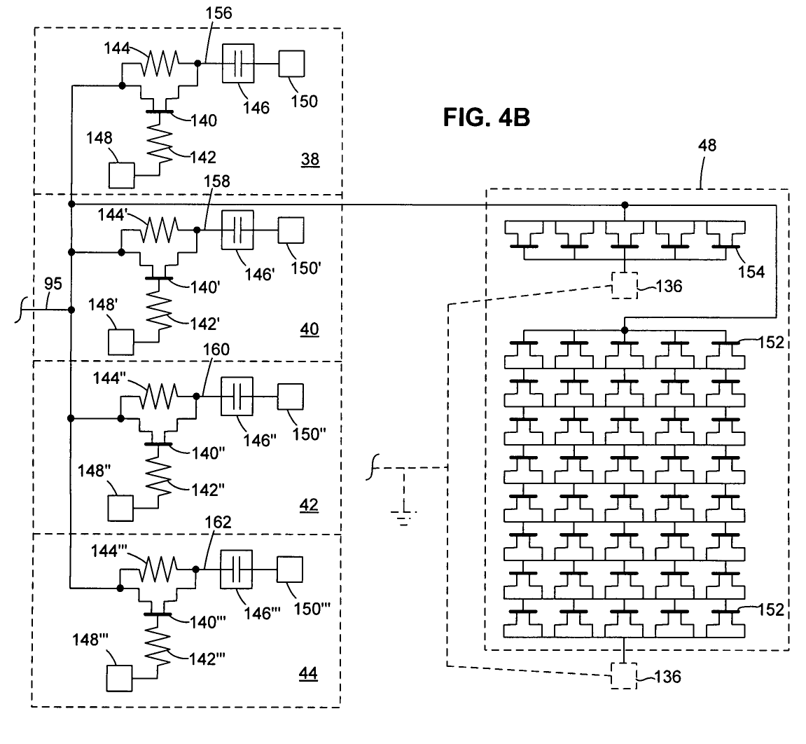

As illustrated in FIG. 4A, in the exemplary embodiment of the invention transmit port circuit 34 can comprise a pair of multi-gate FETs 52 and 54, with the drain terminal of FET 52 connected to the source terminal of FET 54, and the source terminal of FET 52 connected via a DC-blocking capacitor 56 to an input/output (I/O) pad 58 that serves as the port node. In manufacturing the telecommunications device or MCM, I/O pad 58 is connected the output of a power amplifier chip (not shown). The drain terminal of FET 54 is connected to an I/O pad 60 to which antenna 12 (FIGS. 1-3) is connected in manufacturing the telecommunications device. A resistor 62 is connected between the source and drain terminals of FET 52, and another resistor 64 is connected between the source and drain terminals of FET 54. A capacitor 66 is connected between the source terminal and a first gate terminal of FET 52, and another capacitor 68 is connected between the drain terminal and a second gate terminal of FET 52. The first and second gate terminals of FET 52 are also coupled via respective resistors 70 and 72 and a common resistor 74 to an I/O pad 76 that serves as the activation input for transmit port circuit 34. A third gate terminal of FET 52 is coupled to I/O pad 76 via another resistor 78 and the common resistor 74.

The FET 54 is connected in a manner similar to that described above for FET 52. Accordingly, a capacitor 80 is connected between the source terminal and a first gate terminal of FET 54, and another capacitor 82 is connected between the drain terminal and a second gate terminal of FET 54. The first and second gate terminals of FET 54 are also coupled via respective resistors 84 and 86 and a common resistor 88 to I/O pad 76. A third gate terminal of FET 54 is coupled to I/O pad 76 via another resistor 90 and the common resistor 88.

In the exemplary embodiment, transmit port circuit 36 is identical to above-described transmit port circuit 34 and is therefore not described herein in similar detail. Note that although the exemplary embodiment includes only two transmit port circuits 34 and 36, other embodiments can have any other suitable number and type of transmit port circuits.

As further illustrated in FIG. 4A, voltage-dividing switching circuit 46 can comprise a pair of multi-gate FETs 92 and 94, with the drain terminal of FET 92 connected to the source terminal of FET 94, and the source terminal of FET 92 connected to antenna I/O pad 60. The drain terminal of FET 94 defines a node 95 that is connected to the switched nodes of receive port circuits 38-44, which are described below with regard to FIG. 4B. A resistor 96 is connected between the source and drain terminals of FET 92, and another resistor 98 is connected between the source and drain terminals of FET 94. A capacitor 100 is connected between the source terminal and a first gate terminal of FET 92, and another capacitor 102 is connected between the drain terminal and a second gate terminal of FET 92. The first and second gate terminals of FET 92 are also coupled via respective resistors 104 and 106 and a common resistor 108 to an I/O pad 110 that serves as the activation or control input for switching circuit 46. A third gate terminal of FET 92 is coupled to I/O pad 110 via another resistor 112 and the common resistor 108.

The FET 94 is connected in a manner similar to that described above for FET 92. Accordingly, a capacitor 114 is connected between the source terminal and a first gate terminal of FET 54, and another capacitor 116 is connected between the drain terminal and a second gate terminal of FET 94. The first and second gate terminals of FET 94 are also coupled via respective resistors 118 and 120 and a common resistor 122 to I/O pad 110. A third gate terminal of FET 94 is coupled to I/O pad 110 via another resistor 124 and the common resistor 122.

Voltage-dividing switching circuit 46 also includes a shunt circuit, comprising a FET 126, a resistor 128 connected between the source and drain terminals of FET 126, two capacitors 130 and 132, and a resistor 134. (Note that in the exemplary embodiment FET 126 is a single-gate device and not one of the multi-gate devices described above.) Capacitor 132 is connected between the source terminal of FET 126 and the switched nodes of receive port circuits 38-44, which are described below with regard to FIG. 4B. Capacitor 130 is connected between the drain terminal of FET 126 and an I/O pad 136 that is connected to ground potential. As indicated by the broken line extending from I/O pad 136, and as described below with regard to FIG. 4B where the broken line continues, diode-based ESD protection circuit 48 can share this same I/O pad 136. Lastly, a resistor 138 is connected between the drain terminal of FET 126 and I/O pad 110 to complete the coupling of the shunt circuit to the remaining circuitry of voltage-dividing switching circuit 46.

As illustrated in FIG. 4B, each of receive port circuits 38-44 includes a FET 140, two resistors 142 and 144, and a DC-blocking capacitor 146. (Note that in the exemplary embodiment FET 140 is also a single-gate device.) Resistor 144 is connected between the source and drain terminals of FET 140. The gate terminal of FET 140 is connected via resistor 142 to an I/O pad 148, which serves as the activation input. The drain terminal of FET 140 is connected via DC blocking capacitor 146 to an I/O pad 150, which serves as the output port node. In manufacturing the telecommunications device, I/O pad 150 is connected to an input of transceiver circuitry 26 (FIG. 1) to process the received signal. The source terminal of FET 140 defines the switched node and is connected to the output of voltage-dividing switching circuit 46 (FIG. 4A).

In the exemplary embodiment, receive port circuits 38-44 are identical to each other. However, in other embodiments they can be different from each other, and there can be more or fewer than the four receive port circuits 38-44 of the exemplary embodiment.

In the exemplary embodiment, the ESD protection circuit 48 comprises an array of FETs 152. Each FET 152 is configured with its source and drain terminals connected together to define a diode device, i.e., a device that functions as a diode. In other embodiments, other types of diode devices, including true diodes and other types of transistors, can be employed instead. In the exemplary embodiment, the array comprises five parallel strings of FETs 152, with each string having eight FETs 152 arranged in series with each other such that the gate terminal of one FET 152 is connected to the source and drain terminals of the adjacent FET 152 in the series. The strings are arranged in parallel with each other, such that the source and drain terminals of each FET 152 in a string are connected to the source and drain terminals of the correspondingly disposed FET 152 in each of the other strings. The source and drain terminals of the last FET 152 in each string are connected to ground potential through I/O pad 136, which is shared with voltage-dividing switching circuit 46 (FIG. 4A). The gate terminals of the first FET 152 in each string are connected to the node 95 that defines the output of voltage-dividing switching circuit 46 and the inputs of receive port circuits 38-44. In this arrangement, each of FETs 152 functions as a forward-biased diode.

One or more reverse-biased diode devices can also be included. As further shown in FIG. 4B, five FETs 154 are connected in a manner similar to FETs 152 but in a reverse-biased configuration. The drain and source terminals of FETs 154 are connected together and, as with FETs 152, to the node that defines the output of voltage-dividing switching circuit 46 and the inputs of receive port circuits 38-44. The gate terminals of FETs 154 are likewise connected together and to ground potential through I/O pad 136.

It is important to note that the node 95 that defines the output of voltage-dividing switching circuit 46 and the inputs of receive port circuits 38-44 has a lower RF voltage swing than that of antenna node 50 (FIG. 3) when either of transmit port circuits 34 and 36 is turned on (i.e., activated) because FETs 92 and 94 are turned off and FET 126 is turned on, under control of the above-mentioned controller (not shown). This creates a voltage divider between antenna node 50 and the node 95 to which diode-based ESD protection circuit 48 is connected as a result of the high impedance of FETs 92 and 94 in the “off” state working against the low impedance to ground through FET 126 and capacitors 132 and 134. This voltage division, which causes node 95 to experience a lower voltage swing than antenna node 50, promotes the use of fewer diode devices than in some conventional ESD protection circuits. In the exemplary embodiment, when a positive (with respect to ground) ESD voltage at node 95 rises above a threshold voltage of about 5.6 volts, i.e., the sum of the voltage drops across FETs 152 (approximately 0.7V each), FETs 152 (acting as diodes) turn on and thus provide a low-impedance path to safely discharge the current from node 95 to ground through I/O pad 136. The reverse-biased FETs 154 similarly provide ESD protection against negative ESD voltages.

Although in the exemplary embodiment there are five parallel strings, each having eight FETs 152, in other embodiments there can be any other suitable number. As noted above, the present invention enables fewer diode devices to be employed than in many conventional diode-based ESD protection circuits. As those skilled in the art appreciate, an effective conventional diode-based ESD protection circuit can conceivably employ so many diodes that the circuit area or real estate it occupies can be greater than that occupied by the circuitry it is intended to protect. In accordance with the exemplary embodiment of the present invention, between seven and ten FETs 152 in each string is believed to be an optimal number, as fewer than seven FETs 152 in each parallel string can draw excessive current from the battery (not shown) when one of receive port circuits 38-44 is active, resulting in the need to recharge or replace the battery more frequently, while having more than ten FETs 152 in each string inefficiently consumes chip area and also increases the equivalent series resistance of the FETs 152. A higher series resistance allows the voltage developed at the node to which ESD protection circuit 48 is connected to increase during an ESD strike, which can cause the reverse-biased FETs 154 to exceed their breakdown voltage, resulting in device failure. Increasing the number of reversed-biased FETs 154 in each string allows the node at which ESD protection circuit 48 is connected to operate at a higher voltage, thus improving circuit ESD performance. The equivalent series resistance of FETs 152 can be reduced by increasing the number of parallel strings of FETs 152 in order to improve ESD performance, but the resulting increase in capacitance can degrade the signal quality of the received RF signal as it shunts some of the signal away from receive port circuits 38-44 to ground through I/O pad 136. In some embodiments, RF impedance matching can be included to compensate for the additional capacitance.

It should also be appreciated that ESD protection circuit 48 protects not only receiver port circuits 38-44 to which it is directly connected but also transmit port circuits 34 and 36 to which it is indirectly connected (i.e., coupled via voltage-dividing switching circuit 46). This is true because the FETs in RF switching circuit 30 are depletion mode FETs, which require a negative voltage to turn them off. Without any DC bias applied to the FETs in RF switching circuit 30, all the FETs are turned on. Therefore, in the event of an ESD strike on any of the I/O pads in RF switching circuit 30, the ESD signal has a path to ground through ESD protection circuit 48 and I/O pad 68. This FET characteristic enables ESD protection circuit 48 to be connected any suitable node while still providing ESD protection to the other circuitry. For example, although in the exemplary embodiment ESD protection circuit 48 is connected to node 95, in other embodiments it can alternatively be connected to any one of: a node 156 between FET 140 and DC-blocking capacitor 146; a node 158 between FET 140′ and DC-blocking capacitor 146′; a node 160 between FET 140″ and DC-blocking capacitor 146″; or a node 162 between FET 140′″ and DC-blocking capacitor 146′″.

While exemplary embodiments of the invention have been described, it will be apparent to those of ordinary skill in the art that other embodiments and implementations are possible that are within the scope of this invention. Accordingly, the invention is not to be restricted except in light of the following claims.

What is claimed is:

1. An electrostatic discharge (ESD)-protected radio frequency (RF) transceiver switching circuit, comprising:
a plurality of switchable RF transmit and receive port circuits, each having a port node, an activation input, and a switched node, the switched node of each of the RF transmit and receive port circuits coupled to a common antenna node;
a voltage-dividing circuit having a first node coupled to the common antenna node and a second node coupled to the switched node of at least one of the transmit and receive port circuits; and
a diode circuit coupled between the second node of the voltage-dividing circuit and a ground node to provide a discharge path to ground in response to ESD at any one or more of the common antenna node and transmit and receive port circuits, the diode circuit comprising plurality of diode devices connected in series with each other.

2. The ESD-protected RF transceiver switching circuit claimed in claim 1, wherein the diode circuit comprises a plurality of forward-biased diode devices.

3. The ESD-protected RF transceiver switching circuit claimed in claim 2, wherein the diode circuit further comprises at least one reverse-biased diode device connected between the second node of the voltage-dividing circuit and the ground node.

4. The ESD-protected RF transceiver switching circuit claimed in claim 2, wherein each diode device comprises a field-effect transistor (FET) having a source node coupled to a drain node.

5. The ESD-protected RF transceiver switching circuit claimed in claim 4, wherein the diode circuit comprises between no fewer than seven and no more than ten diode devices connected in series with each other.

6. The ESD-protected RF transceiver switching circuit claimed in claim 1, wherein:
the at least one of the transmit and receive port circuits having the switched node to which the second node of the voltage-dividing circuit is coupled consists of a plurality of receive port circuits; and
the voltage-dividing circuit comprises a voltage-dividing switch to deactivate the plurality of receive port circuits to which the second node of the voltage-dividing circuit is coupled when the RF transceiver switching circuit is in a transmit mode, wherein in the transmit mode one of the transmit port circuits of the plurality of transmit and receive port circuits is active.

7. The ESD-protected RF transceiver switching circuit claimed in claim 6, wherein:
each of the plurality of transmit port circuits comprises a pair of multi-gate field-effect transistors (FETs);
the voltage-dividing switch comprises a pair of multi-gate FETs; and
each of the plurality of receive port circuits comprises no more than one FET, and the no more than one FET has no more than one gate.

8. A mobile wireless telecommunications device, comprising:
a user interface subsystem;
a baseband subsystem;
an antenna; and
a transceiver subsystem, the transceiver subsystem including an electrostatic discharge (ESD)-protected radio frequency (RF) switching circuit, the ESD-protected RF switching circuit comprising:
a plurality of switchable RF transmit and receive port circuits, each having a port node, an activation input, and a switched node, the switched node of each of the RF transmit and receive port circuits coupled to the antenna;
a voltage-dividing circuit having a first node coupled to the antenna and a second node coupled to the switched node of at least one of the transmit and receive port circuits; and
a diode circuit coupled between the second node of the voltage-dividing circuit and a ground node to provide a discharge path to ground in response to ESD at any one or more of the antenna and transmit and receive port circuits, the diode circuit comprising plurality of diode devices connected in series with each other.

9. The mobile wireless telecommunications device claimed in claim 8, wherein the diode circuit comprises a plurality of forward-biased diode devices.

10. The mobile wireless telecommunications device claimed in claim 9, wherein the diode circuit further comprises at least one reverse-biased diode device connected between the second node of the voltage-dividing circuit and the ground node.

11. The mobile wireless telecommunications device claimed in claim 9, wherein each diode device comprises a field-effect transistor (FET) having a source node coupled to a drain node.

12. The mobile wireless telecommunications device claimed in claim 11, wherein the diode circuit comprises between no fewer than seven and no more than ten diode devices connected in series with each other.

13. The mobile wireless telecommunications device claimed in claim 8, wherein:
the at least one of the transmit and receive port circuits having the switched node to which the second node of the voltage-dividing circuit is coupled consists of a plurality of receive port circuits; and
the voltage-dividing circuit comprises a voltage-dividing switch to deactivate the plurality of receive port circuits to which the second node of the voltage-dividing circuit is coupled when the RF transceiver switching circuit is in a transmit mode, herein in the transmit mode one of the transmit port circuits of the plurality of transmit and receive port circuits is active.

14. The mobile wireless telecommunications device claimed in claim 13, wherein:
each of the plurality of transmit port circuits comprises a pair of multi-gate field-effect transistors (FETs);
the voltage-dividing switch comprises a pair of multi-gate FETs; and
each of the plurality of receive port circuits comprises no more than one FET, and the no more than one FET has no more than one gate.
